(19) United States
(12) Patent Application Publication
(10) Pub. No.: US 2016/0249776 A1
(43) Pub. Date: Sep. 1, 2016

(54) BODY CLEANING HEAD AND BODY CLEANING TOOL

(71) Applicant: BOE TECHNOLOGY GROUP CO., LTD., Beijing (CN)

(72) Inventor: Liang LI, Beijing (CN)

(21) Appl. No.: 14/758,006

(22) PCT Filed: Jan. 4, 2015
(86) PCT No.: PCT/CN2015/070019

§ 371 Date: Jun. 26, 2015

(30) Foreign Application Priority Data
Sep. 22, 2014 (CN) 201410486475.6

(51) Int. Cl. A47K 7/04; B05B 15/04; B05B 1/00

(52) U.S. Cl. CPC A47K 7/04; B05B 1/00; B05B 15/04

(57) ABSTRACT

A body cleaning head includes an outer case provided with a suction port and provided therein with a reflow passage communicating with the suction port; an a water pipe assembly provided within the reflow passage; the water pipe assembly includes a pipe bracket fixedly provided within the outer case, a water discharge hose is inserted and fitted within the pipe bracket and an end of the water discharge hose adjacent to the suction port is protruded from the pipe bracket, and around the protruded end, an elastic body and a slide sleeve are provided, the elastic body is located between the pipe bracket and the slide sleeve, and the slide sleeve is axially movable relative to the pipe bracket. A body cleaning tool is further provided.

### TECHNICAL FIELD

Embodiments of the present invention relate to a body cleaning head and a body cleaning tool.

### BACKGROUND

For a person to whom it is inconvenient to clean his/her body in a conventional manner, usually, cleaning is usually carried out by using a body cleaner with a body cleaning head; by contacting the body cleaning head with the person's skin, his/her body can be cleaned and at the same time dirty water after cleaning can be drawn back to the cleaning device.

In order to achieve functions of cleaning body and drawing back the dirty water after cleaning at the same time, as illustrated in FIG. 1, the body cleaning head comprises an outer case 01, the outer case 01 is provided therein with a suction port 011 and a return flow passage 012 communicating with the suction port, the outer case 01 is also provided therein with a outflow pipe 02, the clean water flows in a direction as indicated by an arrow in the outflow pipe 02 and is sprayed onto the skin from the outlet of the outflow pipe. After cleaning, dirty water is drawn into the flow return passage 012 by a suction motor (not shown) from the suction port 011 in a direction indicated by an arrow. When the suction motor is operated, it can not be kept at a stable state for a long time.

Therefore, the unstable operation of the suction motor causes the suction effect vary from time to time, when the suction power is large, clean water to be sprayed out of the outlet is drawn away by the suction motor before it reaches the skin, and the effect of cleaning the body cannot be achieved; and when the suction power is small, dirty water after cleaning cannot be effectively drawn back to the body cleaning device in time, but will flow to other positions, the function of dirty water recycle cannot be achieved well.

### SUMMARY

At least one embodiment of the present disclosure provides a body cleaning head and a body cleaning tool, which are capable of achieving a relative stable state of the water outflow velocity from an outlet and that of the suction power of a suction port, and achieving good effect of cleaning the body and drawing dirty water back to a cleaning machine.

At least one embodiment of the present disclosure provides a body cleaning head comprising: an outer case provided with a suction port and a flow return passage communicated with the suction port; and a water pipe assemble provided in the flow return passage and comprising a pipe bracket fixedly provided in the outer case. A water discharge hose is inserted and fitted within the pipe bracket, and an end of the water discharge hose adjacent to the suction port is protruded from the pipe bracket, and around the protruded end, an elastic body and a slide sleeve are provided, the elastic body is located between the pipe bracket and the slide sleeve, and the slide sleeve is axially movable relative to the pipe bracket under an action of air flow to press the water discharge hose so that an inner diameter of a portion of the water discharge hose corresponding to the elastic body can be varied.

According to one embodiment of the present disclosure, the slide sleeve is a conical sleeve, and an end with a smaller diameter is provided near the suction port of the outer case.

According to one embodiment of the present disclosure, the inner wall of the slide sleeve is formed with an annular slot, the elastic body is placed in the annular slot, and an end of the pipe bracket is inserted into the annular slot and abuts against the elastic body.

According to one embodiment of the present disclosure, the elastic body is an elastic ring, and the maximum diameter of the annular slot matches the outer diameter of the elastic ring.

According to one embodiment of the present disclosure, the elastic body comprises a plurality of elastic block.

According to one embodiment of the present disclosure, the water outlet of the water discharge hose is located in the outer case, and the suction port of the outer case is provided at a distance from the water outlet of the water discharge hose in the axial direction.

According to one embodiment of the present disclosure, the distance from the suction port of the outer case to the water outlet of the water discharge hose in the axial direction is less than or equal to a spraying distance of the water outlet.

According to one embodiment of the present disclosure, the distance from the suction port of the outer case to the water outlet of the water discharge hose in the axial direction is less than the spraying distance of the water outlet by from lcm to 2 cm.

According to one embodiment of the present disclosure, the elastic body is made of a rubber material.

At least one embodiment of the present disclosure further provides a body cleaning tool comprising a water supply motor and a suction motor, and further comprising any one of the body cleaning heads as described above. The water supply motor communicates with the water discharge hose, and the suction motor communicates with the return flow passage of the body cleaning head, the suction motor can suck ambient air and the water flow sprayed by the water discharge hose back into the cleaning tool.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic view showing the structure of the body cleaning head known by the inventor;

FIG. 2 is a schematic sectional view showing the structure of the body cleaning head, which is in a non-open state, according to an embodiment of the present disclosure;

FIG. 3 is a schematic sectional view showing the structure of the body cleaning head, which is in an operation state and contacts a skin, according to the embodiment of the present disclosure; and

FIG. 4 is a schematic sectional view showing the structure of the body cleaning head, which is in an operation state but does not contact the skin, according to the embodiment of the present disclosure.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

In the description of the present disclosure, it should be noted that the orientation or position relationship indicated by the terms “center”, “up”, “down”, “front”, “rear”, “left”, “right”, “vertical”, “horizontal”, “top”, “bottom”, “inner”, “outer” and so on is based on the orientation or position relationship as indicated by the figures, and is only intended to facilitate the description of the present disclosure and simplify the description, and should not be construed as to indicate or imply the referred devices or members must have the particular orientation, is constructed and operated by the particular construction, and thus should not be interpreted as limitations to the present disclosure. In addition, the terms “first”, “second” and so on are only used for descriptive purpose, and should not be interpreted as indicating or implying the significance or implicitly indicating the number of the indicated technical features. Therefore, the feature prefixed with the terms “first”, “second” can clearly or implicitly indicate comprising one or more such features.

In the description of the present disclosure, it should be noted that, unless expressly stated and defined to the contrary, the terms “amount”, “connect”, “connection” should be interpreted in its broadest sense, for example, it may be a permanent connection or a releasable connection, or an integral connection; it may be a mechanical connection, or a electrical connection; it may be a direct connection or an indirect connection via an intervenient member; it may be communication between the interiors of two members. The meaning of the above terms in the present disclosure can be suitably understood by the person skilled in the art according to the practical situation.

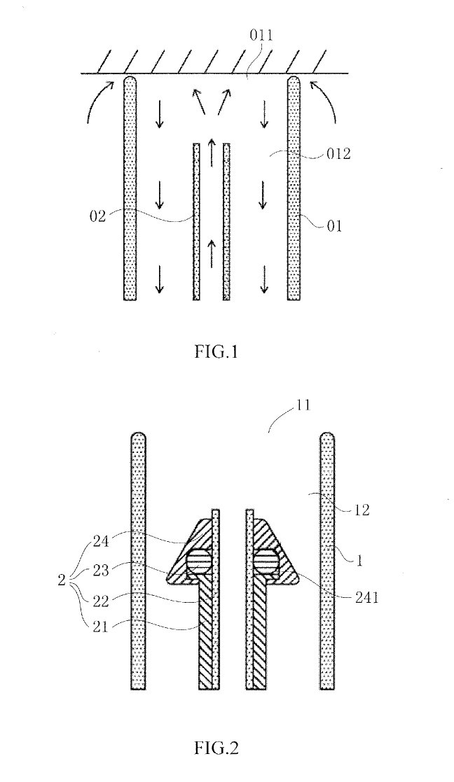

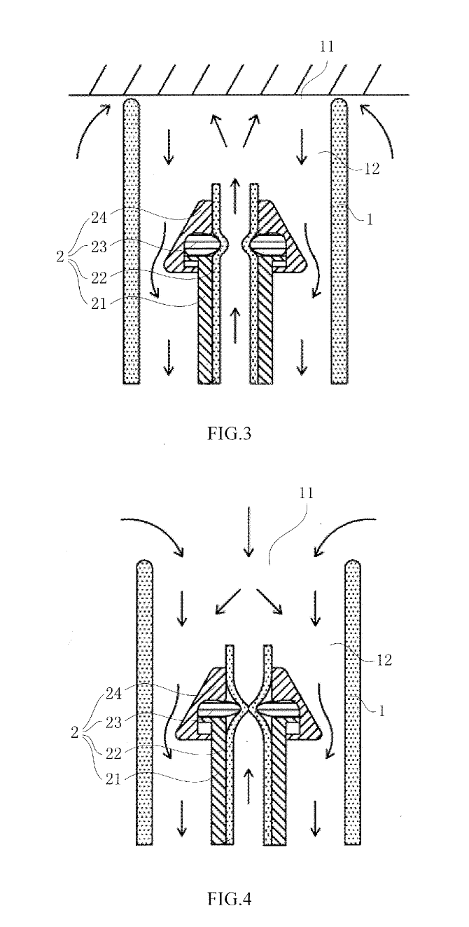

FIG. 2 and FIG. 3 are schematic views showing the sectional structure of a body cleaning head according to one embodiment of the present disclosure. Referring to FIG. 2 and FIG. 3 the body cleaning head according to the present embodiment includes an outer case 1 provided with a suction port 11 and provided therein with a reflow passage 12 communicating with the suction port 11; and a water pipe assembly 2 provided within the reflow passage 12, the water pipe assembly 2 includes a pipe bracket 21 fixedly provided in the outer case 1, a water discharge hose 22 is inserted and fitted within the pipe bracket 21, an end of the water discharge hose 22 adjacent to the suction port 11 is protruded out of the pipe bracket 21, and an elastic body 23 and a slide sleeve 24 are provided around the protruded end, the elastic body 23 is located between the pipe bracket 21 and the slide sleeve 24, and the slide sleeve 24 is axially movable relative to the pipe bracket 21. When the cleaning head sucks air, the air flow in the reflow passage 12 pushes the slide sleeve 24 to move towards the pipe bracket 21 and press the elastic body 23, such that the size of the elastic body 23 in the radial direction of the water discharge hose is enlarged, and thus the water discharge hose 22 is pressed so that inner diameter of the portion of the water discharge hose 22 corresponding to the elastic body 23 is reduced. When the air pressure of the suction port is changed from large to small, the slide sleeve 24 is moved in a direction away from the pipe bracket 21, such that the size of the elastic body 23 in the radial direction of the water discharge hose is reduced, and thus the inner diameter of the portion of the water discharge hose 22 corresponding to the elastic body 23 is increased.

The body cleaning head provided by the present embodiment includes the outer case 1 and the water pipe assembly 2. When the body cleaning head is put in operation, air suction and water discharging are performed at the same time; in this case, referring to FIG. 4, when the cleaning head does not contact with skin yet, the air pressure in the reflow passage 12 is maximum and is equal to the atmospheric pressure, and the air flow in the reflow passage 12 flows along the direction as indicated by the downward arrow in the drawing, and pushes the slide sleeve 24 to move in the direction approaching the pipe bracket 21 towards the maximum extent and presses the elastic body 23 in such a manner that the size of the elastic body 23 in the radial direction of the pipe discharging hose is increased and thus the water discharge hose 22 is pressed to be deformed to the maximum extent and accordingly the inner diameter of the portion of the water discharge hose 22 corresponding to the elastic body is reduced toward the minimum extent, approaching to a close state; therefore, when the cleaning head does not contact with the skin, the water will not be sprayed from the cleaning head. Given the water pressure in the water discharge hose 22 is constant, the spray distance of the water outlet is related to both the cross-sectional area of the water outlet and the pressure in the suction port 11. Therefore, when the pressure of the suction port 11 is not stable, the spray distance of the water outlet can be guaranteed by changing the cross-sectional area of the water outlet. Referring to FIG. 3, when the cleaning head contacts with the skin, a relative large resistant force is generated when air is sucked, but the air pressure in the reflow passage 12 is less than the atmospheric pressure, the pressure acting on the slide sleeve 24 is reduced, and thus the displacement amount, by which the slide sleeve 24 is moved, is reduced. Accordingly, the deformation amount of the elastic body 23 is reduced, the inner diameter of the portion of the water discharge hose 22 corresponding to the elastic body 23 is increased, and the water discharge hose 22 is opened, so that the water in the water discharge hose 23 can be flowed along the direction as indicated by the upward arrow in the drawing and is sprayed on the skin to clean the skin. During cleaning, the suction power may be varied, when the suction power is increased, the pressure in the reflow passage 12 is increased, and thus the displacement amount of the slide sleeve 24 and the deformation amount of the elastic body 23 are both increased, and the inner diameter of the portion of the water discharge hose corresponding to the elastic body 23 is reduced, and the water discharge velocity becomes faster, that is, as the suction power is increased, the water discharge velocity is also increased, therefore, the problem that the water from the water discharge pipe is drawn away before it reaches the skin when the suction power is increased can be avoided. When the suction power is reduced, the pressure in the reflow passage 12 is reduced, thus the displacement amount of the slide sleeve 24 and the deformation amount of the elastic body 23 are also reduced, the inner diameter of the portion of the water discharge hose corresponding to the elastic body 23 is enlarged, and the water discharge velocity of the cleaning head is slowed down accordingly, that is, as the suction power is reduced, the water discharge velocity of the cleaning head is also slowed down, therefore, the problem that the dirty water cannot be drawn away after cleaning the skin in time can be avoided. After the cleaning is completed, when the cleaning head is moved away from the skin, the air pressure in the reflow passage 12 is recovered to be equal to the atmospheric pressure, and thus the water will not be sprayed out any more. Therefore, as long as water discharging and air suction are performed at the same time, the body cleaning tool can also automatically adjust the open or close of the water discharge hose 22 according to whether or not the cleaning head contacts with the skin.

The slide sleeve 24 may be a cylindrical sleeve or a conical sleeve; where a cylindrical sleeve is used, the area to be forced is the bottom surface of the cylinder, which therefore facilitates the slide sleeve 24 to be pushed by force to move. In one embodiment of the present disclosure, the slide sleeve 24 is a conical sleeve, and the end with a smaller diameter is provided near the suction port 11 of the outer case 1, and the pressure in the reflow passage 12 is acted on the end with a smaller diameter so that both this end and the conical side surface are forced, the area to be acted is increased, thus the slide sleeve 24 can be more easily moved under the effect of the pressure.

In order that the elastic body 23 is more stably operated, an annular slot 241 is provided in the inner wall of the slide sleeve 24, and the elastic body 23 is provided in the annular slot 241, and an end of the pipe bracket 21 is inserted into the annular slot 241 and is abutted against the elastic body 23, so that the elastic body 23 is firmly held in the annular slot 241, and the reliability of the elastic body 23 upon operation is guaranteed. In one embodiment of the present disclosure, the elastic body 23 may be made from a rubber material.

The elastic body 23 may include a plurality of elastic blocks distributed in the annular slot 241, the elastic block each may be of a sphere shape or a cubic shape. The elastic body 23 may also be a single elastic ring. In one embodiment, to guarantee the operation stability of the elastic body 23, when the elastic body 23 is of a elastic ring, in order to avoid the response delay when the elastic ring is pressed, the maximum diameter of the annular slot 241 is comparable with the outer diameter of the elastic ring, once the slide sleeve 24 is displaced, a deformation amount is occurred immediately in the elastic ring and acts on the water discharge hose 22, thus it can be guaranteed that the water discharge velocity can be varied upon the suction power being changed, and thus the cleaning effect can be guaranteed.

In order to guarantee sufficient time for the water sprayed from the water outlet of the water discharge hose 22 to clean the skin before it is drawn away, the water outlet of the water discharge hose 22 should be positioned within the outer case 1, and the suction port 11 of the outer case 1 is provided at a distance apart from the water outlet of the water discharge hose 22 along the axial direction.

In one embodiment of the present disclosure, the distance by which the suction port 11 of the outer case 1 is separated away from the water outlet of the water discharge hose 22 along the axial direction should be less than or equal to a spray distance of the water outlet; with this configuration, upon operation, the water can be spray onto the skin at a suitable force.

In order to avoid the problem that the water from the water outlet brings uncomfortable feeling to the skin due to the spray distance is too large or the water velocity is too fast in cleaning the skin, the difference between the distance by which the suction port 11 of the outer case 1 is separated away from the water outlet of the water discharge hose 22 along the axial direction and the spray distance of the water outlet should not be too large, for example, the difference is from 1 cm to 2 cm.

At least one embodiment of the present disclosure also provides a body cleaning tool, the body cleaning tool includes a water supply motor (not shown in figures) and a suction motor (not shown in figures), and further includes a body cleaning head as described in any of the above embodiments, the water supply motor communicates with the water discharge hose 22, and the suction motor communicates with the reflow passage 12 of the body cleaning head, the ambient air and the water sprayed out of the water discharge hose 22 can be drawn back into the cleaning tool by the suction motor through the reflow passage 12.

By the restriction of the two conditions of the constant water pressure and the limited deformation amount, the water outflow velocity is limited in a certain range; therefore, the amount of the corresponding suction force should also be limited in a certain range. If the suction force is too large, the water discharge hose 22 will always be closed; and if the suction force is too small, the water outflow velocity is excessively fast, and will bring uncomfortable feeling to the user upon cleaning, and the sprayed water may not be fully recovered. Therefore, in selecting the elastic body 23, the elastic coefficient of the elastic body 23 should match with the power of the suction motor and the power of the water supply motor.

Other components for the body cleaning tool of the embodiments of the present disclosure may adopt those well known by the person skilled in the art and will not be further described in detail.

The features, structures, materials or the characters described in the present disclosure can be combined in any suitable way in any one or more embodiments or examples.

The present disclosure has been described above by way of the exemplary embodiment, and the protection scope of the present disclosure would not be limited therein, and is only defined by the following claims.

The present application claims the priority of Chinese Patent Application No. 201410486475.6 filed on Sep. 22, 2014, the Chinese Patent Application is entirely incorporated therein as a part of the present application by reference.

1. A body cleaning head comprising:
an outer case provided with a suction port and provided therein with a reflow passage communicating with the suction port; and
a water pipe assembly provided within the reflow passage, wherein the water pipe assembly includes a pipe bracket fixedly provided in the outer case, a water discharge hose is inserted and fitted within the pipe bracket and an end of the water discharge hose adjacent to the suction port is protruded from the pipe bracket, and around the end an elastic body and a slide sleeve are provided, the elastic body is located between the pipe bracket and the slide sleeve, the slide sleeve is axially movable relative to the pipe bracket under an action of the airflow pressure in such a manner that the elastic body presses the water discharge hose and inner diameter of a portion of the water discharge hose corresponding to the elastic body is varied with the airflow pressure.

2. The body cleaning head according to claim 1, wherein the slide sleeve is a conical sleeve, and an end with a smaller diameter is provided adjacent to the suction port of the outer case.

3. The body cleaning head according to claim 1, wherein, an annular slot is formed in the inner wall of the slide sleeve, the elastic body is placed in the annular slot, and an end of the pipe bracket is inserted into the annular slot and abuts against the elastic body.

4. The body cleaning head according to claim 3, wherein the elastic body is an elastic ring, and the maximum diameter of the annular slot is comparable with the outer diameter of the elastic ring.

5. The body cleaning head according to claim wherein the elastic body includes a plurality of elastic blocks.

6. The body cleaning head according to claim 1, wherein a water outlet of the water discharge hose is located in the outer case, and the suction port of the outer case is provided at a distance away from the water outlet of the water discharge hose along an axial direction.

7. The body cleaning head according to claim 1 wherein the distance by which the suction port of the outer case is separated from the water outlet of the water discharge hose along the axial direction is less than or equal to a spray distance of the water outlet.

8. The body cleaning head according to claim 1, wherein the distance by which the suction port of the outer case is separated from the water outlet of the water discharge hose along the axial direction is different from the spray distance by 1 to 2 cm.

9. The body cleaning head according to claim 1, wherein the elastic body is made from a rubber material.

10. A body cleaning tool comprising a water supply motor and a suction motor, and further comprising a body cleaning head according to claim 1, wherein the water supply motor communicates with the water discharge hose, the suction motor communicates with the reflow passage of the body cleaning head, ambient air and water flow sprayed from the water discharge hose can be drawn back into the cleaning tool by the suction motor through the reflow passage.

11. The body cleaning head according to claim 2, wherein, an annular slot is formed in the inner wall of the slide sleeve, the elastic body is placed in the annular slot, and an end of the pipe bracket is inserted into the annular slot and abuts against the elastic body.

12. The body cleaning head according to claim 11, wherein the elastic body is an elastic ring, and the maximum diameter of the annular slot is comparable with the outer diameter of the elastic ring.

13. The body cleaning head according to claim 3, wherein the elastic body includes a plurality of elastic blocks.

14. The body cleaning head according to claim 3, wherein the elastic body is made from a rubber material.

15. The body cleaning head according to claim 2, wherein a water outlet of the water discharge hose is located in the outer case, and the suction port of the outer case is provided at a distance away from the water outlet of the water discharge hose along an axial direction.

16. The body cleaning head according to claim 2, wherein the distance by which the suction port of the outer case is separated from the water outlet of the water discharge hose along the axial direction is less than or equal to a spray distance of the water outlet.

17. The body cleaning head according to claim 2, wherein the distance by which the suction port of the outer case is separated from the water outlet of the water discharge hose along the axial direction is different from the spray distance by 1 to 2 cm.

18. The body cleaning head according to claim 3, wherein a water outlet of the water discharge hose is located in the outer case, and the suction port of the outer case is provided at a distance away from the water outlet of the water discharge hose along an axial direction.

19. The body cleaning head according to claim 3, wherein the distance by which the suction port of the outer case is separated from the water outlet of the water discharge hose along the axial direction is less than or equal to a spray distance of the water outlet.

20. The body cleaning head according to claim 3, wherein the distance by which the suction port of the outer case is separated from the water outlet of the water discharge hose along the axial direction is different from the spray distance by 1 to 2 cm.
